(19) United States
(12) Patent Application Publication
(10) Pub. No.: US 2016/0067950 A1
(43) Pub. Date: Mar. 10, 2016

(54) Packaging Film and Packaging Process

(71) Applicant: Wipak Walsrode GmbH & Co. KG, Bomlitz (DE)

(72) Inventors: Laura Fischer, Nienburg (Weser) (DE); Bernd Sperlich, Walsrode (DE); Dorit Nelke-Bruhn, Wesenberg (DE); Annett Kaeding-Koppers, Bad Fallingbostel (DE)

(21) Appl. No.: 14/847,568

(22) Filed: Sep. 8, 2015

(30) Foreign Application Priority Data
Sep. 8, 2014 (DE) 10 2014 013 827.5

(51) Int. Cl. B32B 27/08; B32B 27/32; B32B 27/34; A23L 3/10; B65B 55/14; B65B 51/10; A23L 3/02; B32B 27/36; B32B 27/10

(52) U.S. Cl. CPC B32B 27/08; B32B 27/36; B32B 27/32; B32B 27/34; B32B 27/10; B65B 55/14; B65B 51/10; A23L 3/02; A23L 3/10; B32B 2307/516; B32B 2307/52; B32B 2439/70; B32B 2307/7242

(57) ABSTRACT

A packaging film having a gas barrier layer and a sealing layer, is constructed such that the gas barrier layer has at least three sublayers with two outer sublayers composed of a polyamide (PA) and a middle sublayer which is arranged between the outer sublayers and is composed of ethylene-vinyl alcohol copolymer (EVOH), which sublayers are coextruded, and wherein the gas barrier layer is monoaxially stretched. Foodstuffs or other products can be packaged and sterilized within the packaging film by putting the product in the film and sealing the packaging by heating or exerting pressure on at least part of the film, and then heating at at least 100C for at least 10 minutes.

### FIELD OF THE INVENTION

The invention relates to a packaging film for packaging products to be sterilized, in particular foodstuffs, where the packaging film has a gas barrier layer and a sealing layer, and the gas barrier layer has at least three sublayers with two outer sublayers composed of a polyamide (PA) and a middle sublayer which is arranged between the outer sublayers and is composed of ethylene-vinyl alcohol copolymer (EVOH), which sublayers are coextruded. The invention additionally relates to a process for packaging products, in particular foodstuffs, and also products packed in a packaging.

### BACKGROUND

Such a packaging film is known from, for example, DE 602 12 816 T2. There, a sterilizable multilayer film is described, which in addition to the three layers of the gas barrier layer has further layers, in particular of polypropylene, on the inside and the outside. These are arranged via bonding agents on the stated layers of the gas barrier layer and form the sealing layer. In the case of the packaging film described in DE 602 12 816 T2, it is considered to be advantageous that it can be produced in a single process step, since all layers are coextruded. The film described is derived from a film known from EP 0 322 891 A2 but has only a sublayer composed of ethylene-vinyl alcohol copolymer and a polyamide layer arranged thereon.

Such films can be used, for example, as lid or pouch film, as a tube pouch or pouch which can stand on its bottom. As lid film, it is used, in particular, on deep drawing plants or shell closure plants known from the prior art, with the film being sealed onto the thermoformed or prefabricated shells in which the product to be packaged is located. This occurs via the sealing layer of the packaging film and the shell.

As pouch film, the film can be processed on all molding-filling-sealing machines (FFS) known and customary from the prior art. The film, optionally in a plurality of film bands, is in this case molded by means of appropriate devices on the packaging machines to form the desired pouch before parts are optionally sealed. The material to be packaged is subsequently introduced and the pouch is finally sealed completely.

In other forms of use, the pouches can be prefabricated from the packaging films described here, e.g. as pouches which can stand on their bottom, on separate machines, so that these prefabricated pouches are subsequently filled with the material to be packaged before the filling opening is sealed. In all these uses, the packaging films according to the invention described here can be used.

Nowadays many different products are packed in a packaging and sterilized therein. These products are, by way of example but not exclusively, foodstuffs, baby food, animal food, pharmaceutical or sanitary products and also medical instruments. A packaging film used for packaging nowadays has at least one gas barrier layer and a sealing layer. The sealing layer is located here on the side facing the product and is used for closing and sealing the respective packaging. For this purpose, it is, for example, brought to an elevated temperature and an increased pressure is applied thereto, leading to sealing of the packaging. The product to be sterilized in the packaging is subsequently sterilized. For sealing, it is also possible to use other methods, for example ultrasonic sealing.

In order to maintain sterility in the interior of the packaging for as long as possible, a series of requirements have to be met by the various layers of the packaging film. In the case of the sealing layer, it is, for example, absolutely necessary for it to be sterilization-resistant. This means, in particular, that it does not soften or even partially melt during later sterilization, since in this case the sealing of the packaging brought about by the sealing layer could be destroyed. At the same time, the sealing layer should be stable at the sometimes elevated temperatures during sterilization. In particular, there must be no migration of low molecular constituents from the film into the interior space of the packaging and thus into the product, which particularly in the case of packaged foodstuffs may be impermissible and would be at least undesirable, however.

The gas barrier layer, on the other hand, has to prevent gas exchange between the interior space of the packaging in which the product is located and the exterior as completely as possible for as long as possible. For this purpose, structural integrity of the film over a prolonged period of time is also necessary.

A series of different packaging films for packaging products to be sterilized are known from the prior art. EP 0 363 540, for example, discloses a film structure in which the sealing layer consists of polypropylene and the gas barrier layer consists of an aluminum foil. A biaxially stretched polyester is used as outer layer. Aluminum foil has very good impermeability to gas, so that it is suitable as gas barrier layer.

However, packaging films are subjected to considerable mechanical stresses during use, for example they are pressed, kinked, bent and deformed in other ways during the packaging process or during transport. This leads to considerable mechanical stresses which, however, must not lead to the gastightness of the gas barrier layer decreasing appreciably. However, the use of aluminum foil as gas barrier layer leads to the gastightness under mechanical stress, known as the “flex-crack” resistance, possibly being only unsatisfactory. In addition, the aluminum foil is not transparent to visible light, so that, for example, consumers who are to buy the packaged product cannot see the product. This is likewise considered to be disadvantageous. Furthermore, aluminum foils below a certain thickness, for example 25 μm, can have “pinholes”, i.e. small holes, caused by their production process, which pinholes naturally impair the gastightness.

The use of a metalized polyester layer as gas barrier layer is therefore known from EP 1 231 053 A1. This is likewise not transparent to visible light but has a better, albeit possibly likewise unsatisfactory flex-crack resistance. In addition, to produce a metalized polyester, it is firstly necessary to produce a polyester layer which is subsequently metalized in a complicated process. Such a film is complicated to produce but cheaper than a pure aluminum layer which is processed further.

Other transparent barrier materials are also known to those skilled in the art. These include, for example, silicon oxide coatings (SiOx), metal oxide vapor deposits, for example aluminum oxide (AlOx), or polymer coatings. However, these all have some susceptibility to mechanical stresses.

A further known barrier material for flexible film packagings is ethylene-vinyl alcohol copolymer (EVOH). This thermoplastic flexible material has a high flex-crack resistance. Its use as gas barrier layer is described, for example, in EP 0 132 565 A2, where the EVOH layer is covered by a layer of a polyamide on at least one side. This layer combination is stretched in at least one direction. Here, the layer lengthens by a factor of from 1.5 to 4 in the respective stretching direction. This improves the gas barrier properties of the layer. However, it has been found that the gastightness of an EVOH layer decreases greatly when it comes into contact with water, as is the case during, in particular, sterilization of products in the interior of a packaging, so that this type of gas barrier is unsuitable for sterilization applications. In this case, “retort shock” occurs. What is meant here is that the gastightness of the gas barrier layer decreases greatly when it comes into contact with moisture.

In an article “Change of barrier properties of high barrier laminates due to flex-crack stress” by the company Amcor, the flex-crack properties of different layer structures of various packaging films were tested. It was found that EVOH which was surrounded on both sides by a polyethylene layer and was arranged on a PET support had, in terms of absolute values, a relatively high gas permeability as gas barrier layer, but this value was impaired only relatively little by deformations and mechanical stresses.

However, information about the temporal length of “retort shock” is unfortunately not to be found in the document. EVOH types which are marketed as suitable for sterilization applications have now been developed. For this purpose, the materials were modified and optimized so that they dry off again after sterilization, in which the coextruded EVOH layer comes into contact with moisture, without delamination from the adjacent layer occurring and without holes, known as vacuoles, being formed. Both would lead to considerable impairment of the barrier, to the film becoming turbid and possibly to disintegration (delamination) of the film.

The initial gas barrier values of the corresponding film can virtually be achieved again in the case of such sterilization-resistant EVOH types. Here, the film remains transparent to visible light. However, the drying-off takes a relatively long time, so that very low barrier values are present immediately after sterilization. During this time, an increased amount of oxygen can thereby get into the packaging, so that the packaged product may spoil earlier and the desired keeping qualities cannot be achieved.

In this case the retort shock can last for a number of days. This is often unsatisfactory, especially for foodstuffs which have been made nonperishable and are present in the packaging but also for medical instruments, since during this time lively gas exchange between the interior space in the packaging and the surroundings may possibly take place.

Providing the combination of EVOH and PA film with an additional layer of silicon oxide is known from JP H04 107138 A. However, this type of layer structure once again leads to a decrease in the resistance to mechanical stresses and thus to a decrease in the “flex-crack” resistance. In addition, this manner of coating is also expensive.

In order to avoid or at least weaken the retort shock, attempts have therefore been made in the prior art to prevent the EVOH layer from coming into contact with moisture during sterilization. For this purpose, layers composed of polypropylene (PP), which have a high barrier action against moisture, were used instead of the surrounding polyamide layers. The moisture which nevertheless penetrates through the polypropylene layer and comes into contact with the EVOH can leave the EVOH layer again only with great difficulty due to the watertightness of the surrounding polypropylene layers, so that this layer structure leads to retort shock which does have a reduced severity but whose duration has been lengthened to up to 14 days. In order to shorten this time, the layer thickness of the polypropylene layers instead has to be increased to such an extent that such layer structures can be used only for rigid containers, for example for ready meals.

The thicker the polypropylene layers are made, the lower the retort shock. Experiments have shown that film structures in which the central EVOH layer is coated on both sides via bonding agents with a polypropylene layer which has a thickness of in each case at least 200 μm can prevent the retort shock virtually completely. However, the total thickness of such films is, for example, 500 μm or more, so that these films cannot be used for flexible lids or pouches. Such film combinations can, for example, be used as deep-drawn self-supporting shells, for example for ready meals. The same layer structure with thinner polypropylene layers, so that the corresponding film remains usable for flexible lids or pouches, does not lead to satisfactory protection of the EVOH layer against moisture during sterilization.

### SUMMARY

It is therefore an object of the invention to propose a packaging film which has high gas-tightness and good flex-crack resistance, is transparent and can be produced in a low thickness and nevertheless can be used in the sterilization of packaged products.

### DETAILED DESCRIPTION

The invention achieves the stated object by means of a packaging film for packaging products to be sterilized, in particular foodstuffs, where the packaging film has a gas barrier layer and a sealing layer, and the packaging film is characterized in that the gas barrier layer is monoaxially stretched and has at least three sublayers with two outer sublayers composed of a polyamide (PA) and a middle sublayer which is arranged between the outer sublayers and is composed of ethylene-vinyl alcohol copolymer (EVOH), which sublayers are coextruded.

The invention is based on the surprising recognition that the known structure of PA/EVOH/PA, which has hitherto been considered to be unsuitable for sterilization applications because of the large retort shock, can be used when the gas barrier layer is monoaxially stretched. The gas barrier layer preferably forms the outside of the packaging film facing away from the product or is covered only by layers which have a great water vapor permeability, preferably at least as good as that of the PA sublayer. Experiments have shown that the retort shock could be restricted to a duration of 4 hours in this way. This means that after 4 hours, the original gas barrier has been completely or at least virtually completely reestablished.

It has been found to be particularly advantageous for the gas barrier layer to be monoaxially stretched in a stretching ratio of from 1.5:1 to 4:1, preferably in a stretching ratio of from 2:1 to 3.5:1, particularly preferably in a stretching ratio of 3:1. This means that the length of the gas barrier layer is increased by the stated factor in the stretching direction.

The high flex-crack resistance and the high gas barrier of the gas barrier layer of the invention are thus combined with the desired transparency to visible light and a very short duration of the retort shock in the packaging film according to the invention which is suitable and provided for sterilization applications. In addition, no coating with or vapor deposition of silicon oxide, metal oxide or metal has to be carried out on, for example, polyester layers, so that the packaging film of the invention can also be produced inexpensively.

The sealing layer preferably consists of a heat-sealable thermoplastic olefin homopolymer or copolymer and is optionally made up of a plurality of sublayers. The material is, for example, selected from a material of the group consisting of ethylene homopolymer, ethylene-a-olefin copolymer, propylene homopolymer and propylene-α-olefin copolymer. Copolyesters can also be preferably used as materials of the sealing layer. The copolyester of the sealing layer is advantageously made up of a dicarboxylic acid and a diol, with the copolyester having a mixture of from 10 to 50 mol % of at least one cycloaliphatic (C₆-C₁₅)-diol and from 90 to 50 mol % of a linear aliphatic (C₂-C₁₀)-diol as diol component and terephthalic acid or a mixture of from 50 to 90 mol % of terephthalic acid and from 10 to 50 mol % of isophthalic acid and/or at least one aliphatic (C₆-C₁₂)-dicarboxylic acid as dicarboxylic acid component. The sealing layer can be produced by all customary production processes, so that, in particular, extrusion or coextrusion processes are also possible. Here, blown film extrusion or flat film extrusion can be used.

In a preferred embodiment, the sealing layer consists at least partly of polypropylene (PP), in particular cast polypropylene. The gas barrier layer and the sealing layer in this case can be adhesively bonded to one another by means of a laminating adhesive in a process known per se from the prior art.

It has been found to be advantageous for the sealing layer to be made up of a plurality of sublayers and for at least one sublayer to consist of polypropylene (PP) and at least one sublayer to consist of polyamide (PA) which are coextruded and joined by means of a bonding agent. It has been found to be particularly advantageous for the sealing layer to consist of at least two sublayers of polyamide (PA) and at least two sublayers of polypropylene (PP) which are coextruded and arranged alternately and are joined by means of a bonding agent. The sealing layer composed of sublayers composed of polypropylene and sublayers composed of polyamide can be produced in a single coextruding process step virtually independently of the respective number of the respective sublayers. To produce a complete packaging film, it is therefore only necessary to produce the sealing layer and the gas barrier layer as separate films in a coextrusion process step in each case or one coextrusion process step with subsequent monoaxial stretching and to laminate these to one another in a conventional manner. The production process for such a film is therefore simple, quick and inexpensive and also easy to control. The mechanical strength of the packaging film can be set via the different numbers of sublayers in the sealing layer. The product to be packed in each case can thus be attended to and, for example, puncture resistance or the general mechanical strength can be increased.

The gas barrier layer of a packaging film according to the invention, which has the at least three-layer structure of two outer polyamide sublayers and an ethylene-vinyl alcohol copolymer middle sublayer, can be produced by conventional extrusion processes. Here, flat film extrusion is preferred. The three layers are coextruded together and subsequently stretched in the direction of travel. Suitable polyamides for such a multilayer film are, in particular, homopolyamides and/or copolyamides which are preferably selected from the group consisting of thermoplastic aliphatic, partially aromatic and aromatic homopolyamides and copolyamides. These can be made up of aliphatic and/or cycloaliphatic diamines having from 2 to 10 carbon atoms, for example hexamethylenediamine, and/or aromatic diamines having from 6 to 10 carbon atoms, for example p-phenylenediamine, and aliphatic and/or aromatic dicarboxylic acids having from 6 to 14 carbon atoms, for example adipic acid, terephthalic acid or isoterephthalic acid. Furthermore, these homopolyamides and copolyamides can be prepared from lactams having from 4 to 10 carbon atoms, for example ε-caprolactam. Homopolyamides and/or copolyamides used in a packaging film according to the invention are preferably selected from the group consisting of PA 6, PA 12, PA 66, PA 6I, PA 6T, corresponding copolymers and mixtures of at least two of the polymers mentioned. As aromatic polyamide, it is also possible to use meta-xylylenediamine.

The EVOH sublayer can advantageously consist of modified ethylene-vinyl alcohol copolymers. Such sterilization-stable EVOH materials are known, for example, from EP 0 322 891.

The gas barrier layer and the sealing layer are advantageously laminated to one another by means of laminating adhesives, i.e. joined to one another by means of a layer of laminating adhesive. As laminating adhesive, it is possible to use an adhesive which is customary in film bonding technology and is suitable for sterilization applications. This is advantageously a two-component polyurethane adhesive. The adhesive is also selected as a function of the materials to be joined, with one-component systems and dispersion adhesives also being possible. Most of the laminating adhesives customarily used in film bonding technology are already transparent, so that the laminating adhesive also does not change the desired transparency of the packaging film to visible light. Lamination is advantageously effected using a weight of applied adhesive of from 2 to 8 g/m². In other embodiments, the individual films can also be joined to one another by means of other known production processes, for example extrusion lamination or extrusion coating.

Even though the actual gas barrier and gas-tightness of the film structure according to the invention are achieved mainly, completely or at least virtually completely by the EVOH sublayer, so that strictly speaking only this forms the gas barrier layer, for the present purposes the three-layer structure of EVOH sublayer and two adjoining polyamide sublayers is regarded as gas barrier layer. As an alternative, this could also be referred to as gas barrier film.

The packaging film preferably additionally comprises a support layer. This support layer, too, can be produced in a conventional way and be joined to the sealing layer and/or the gas barrier layer in order to modify and increase and in particular adapt to the product to be packaged the mechanical strength and stability of the packaging film.

As support layer, biaxially stretched polyamide (BOPA), biaxially stretched polyester (BOPET) or biaxially stretched polypropylene (BOPP) can be advantageously used. Further materials which can be used as support layer are thermoplastic polymers, for example a polyolefin, preferably polyethylene, polypropylene or copolymers thereof, a polyesters, particularly preferably aliphatic or aromatic polyesters, for example polyethylene terephthalate, or a polyamide, particularly preferably aliphatic, partially aromatic or aromatic polyamides, preferably PA 6. Preference is given to transparent materials in order to be able to obtain a packaging film which is transparent overall. The support layers can be monoaxially stretched, in particular in the longitudinal direction, or biaxially stretched in order to achieve appropriate physical properties, for example the required strength. The thickness of the additional support layer is advantageously at least 12 μm.

As an alternative or in addition, it is also possible to use a support layer composed of a paper which is optionally coated or impregnated. If, for example, biaxially stretched polyamide (BOPA) is used as support layer, this leads to increased puncture resistance of the packaging film, which is particularly advantageous for pointed or sharp-edged products which have to be packaged. The use of a support layer composed of paper takes account of, in particular, environmental protection considerations, since in this way the amount of polymer derived from fossil resources necessary for the packaging film can be reduced and at least partly replaced by a renewable raw material such as paper.

The support layer is advantageously arranged between the gas barrier layer and the sealing layer or on a side of the gas barrier layer facing away from the sealing layer. It has been found to be advantageous for the gas barrier layer to be arranged on the outside of the packaging film, i.e. the side facing away from the product to be packaged. In this way, moisture which comes into contact with the gas barrier layer during sterilization of the packaged product can easily leave this gas barrier layer in an outward direction and the gas barrier layer can easily dry in this way. This results in a shortening of and reduction in the retort shock since the time for which the EVOH sublayer comes into contact with moisture and the amount of water which comes into contact with the EVOH sublayer are reduced. In addition, clouding or whitening of the EVOH sublayer due to contact with water, as is known from the prior art, is avoided in the case of a packaging film according to the invention. Such discoloration of the otherwise transparent gas barrier layer is undesirable for the consumer who is to buy the packaged product and should therefore be avoided.

In particular when support materials which have a high water vapor permeability, for example paper, are used, these can also be applied on the outside in order to improve the feel of a packaging made of the packaging film. Thus, it is possible, for example, to use a paper support layer which includes windows in order to allow a view of the product which is to be packed or has been packed. For the present purposes, a high water vapor permeability means, in particular, that the support material of the support layer has a water vapor permeability which is at least as high as that of the polyamide sublayer arranged on the EVOH sublayer.

The water vapor permeability of the layers which cover the gas barrier layer is advantageously at least 75 g/(m² d), i.e. gram per square meter and day. It is particularly preferably at least 250 g/(m² d) and particularly preferably at least 400 g/(m² d). The water vapor permeability has in this case been measured at 23° C. and 85% relative humidity. The measurement can, for example, be carried out in accordance with the standards DIN 53122 or related standards.

If the support layer is arranged on the side of the gas barrier layer facing away from the sealing layer, the feel of the packaging film is changed by the support layer. This is particularly advantageous when using a support layer composed of paper since a customer who picks up the packaged product by hand is in this way immediately told that the product being held is an environmentally friendly product. Were the support layer of paper arranged between the gas barrier layer and the sealing layer, only a visual impression of a paper layer would be given without the customer or the consumer having an opportunity of establishing in another way whether paper has actually been used or whether merely the visual appearance of a paper layer has been reproduced.

Particularly when a combination of a plurality of sublayers composed of polyamide and of polypropylene is used as sealing layer, the use of an additional separate support layer can be superfluous, so that in this case the production process for the packaging film is further simplified and accelerated.

In the case of a packaging film according to one illustrative embodiment of the present invention, the gas barrier layer consists of the two outer sublayers composed of a polyamide which, for example, have a thickness of in each case from 3 to 10 μm, preferably 6 μm. The middle sublayer of EVOH advantageously has a thickness of from 3 to 12 μm, preferably 8 μm. The thickness of the gas barrier layer is preferably in the range from 12 to 30 μm. Possible thicknesses of an additional support layer are in the range from 12 to 50 μm, when using a paper layer in the range from 20 to 70 g/m². Experiments have been carried out using a support layer composed of biaxially stretched polyester having a thickness of 12 μm and biaxially stretched polyamide having a thickness of 15 μm. The thickness of the sealing layer is advantageously in the range from 30 to 120 μm, preferably from 50 to 75 μm.

All packaging films described here can be printed in a wide variety of ways. In particular, printing on the gas barrier layer or the support layer is possible and may be useful. The sealing layer can at least theoretically also be printed. The printing here can be applied frontally, i.e. on the front side, or reversely, i.e. on the rear side, on the respective layer or the film. This makes it possible to apply printing between two layers of the packaging film. This is preferably carried out since the inks are in this way protected against, for example, abrasion. The inks which are used for printing are selected as a function of the chosen printing process and are sterilization-stable in order not to put the sterilization stability of the packaging film at risk. It is possible to use virtually all printing processes known to a person skilled in the art from the prior art, for example gravure printing, flexographic printing or digital printing. Especially when a paper layer is to be printed on, printing on the rear side of the respective layer is naturally not appropriate since this paper layer is not transparent. If a layer which is not transparent to visible light is printed on, printing is advantageously carried out from the front side.

The invention additionally achieves the stated object by means of a process for packaging products, in particular foodstuffs, wherein the process comprises the following steps:
a) arrangement of the product in a packaging which consists at least partly of a packaging film according to one illustrative embodiment of the present invention;
b) sealing of the packaging by increasing the temperature and/or exerting a pressure on at least part of the packaging film;
c) sterilization of the product in the sealed packaging.

The product is advantageously heated at at least 100° C., preferably at least 120° C., particularly preferably at least 130° C., for a time of at least 10 minutes, preferably at least 30 minutes, particularly preferably at least 60 minutes, to effect sterilization. In general, the term sterilization here refers to a process for, in particular, making foodstuffs nonperishable, in which the product to be sterilized is heated at above 100° C., preferably at from 110° C. to 135° C., for from 10 to 60 minutes in the presence of water, steam or pressurized steam.

The invention additionally achieves the stated object by means of a product packed in a packaging, wherein the packaging consists at least partly of a packaging film according to an illustrative embodiment of the present invention and the product has been sterilized in the packaging.

Experiments to measure the oxygen permeability are carried out on films according to the invention using an Ox-tran-2/60 from Mocon Industries. These are carried out at 23° C. and 50% relative atmospheric humidity in accordance with DIN 53380-3.

A Gelbo-Flex tester, model GB from BETEX-Dürbusch, from Hennef, Germany, is used for measuring the flex-crack resistance. Here, the settings for the material class 1 (152 mm strokes; 440° angle of twist) and the template 189×280 mm are selected. The Gelbo-Flex instrument compresses the sample of the packaging film to be tested, which has been rolled to form a 189 mm-long cylinder, to 40 mm, with one side of the cylinder simultaneously being rotated through 440°. It is ensured by means of the construction here that an approximately tensile stress-free twisted body having many disordered creases is formed. In the case of the present tests, 50 cycles are carried out in each case. The effects of the Gelbo-Flex test are determined by means of measurements of the oxygen permeability by comparing unstressed and stressed films having the same film structure. The oxygen permeability is reported here in cubic centimeters per square meter, bar and day. If the value is below 1 cm³/(m² bar d), a satisfactory oxygen barrier is assumed.

The tests are carried out on four different layer structures. The illustrative embodiment of the packaging film of the invention which is used consists of a film which has a gas barrier layer whose outer sublayers are 6 μm thick and whose middle sublayer is 8 μm thick. The outer sublayers consist here of a nucleated polyamide 6 mixed with 10% of a partially aromatic polyamide. This gas barrier layer was monoaxially stretched by a factor of 3 and joined to a 75 μm-thick sealing layer composed of polypropylene (flat film). The EVOH is a sterilization-stable EVOH whose ethylene content is 29%.

This illustrative embodiment of the packaging film of the invention is compared with three different packaging films which are not according to the invention. These are in each case 12 μm-thick gas barrier layers which are likewise arranged on a 75 μm-thick layer composed of polypropylene. The gas barrier layers are BOPET (AlOx vapor-coated), BOPET (SiOx coated), Besela. Besela is a biaxially stretched polyester film coated with modified polyacrylic acid. The total film thickness in the illustrative embodiment of the present invention is 95 μm, while the comparative products have a total layer thickness of 87 μm.

Before the Gelbo-Flex test, the value for the oxygen permeability of all films examined is less than 1 cm³/(m² bar d). After 50 cycles of the Gelbo-Flex test, this applies only to the film according to the illustrative embodiment of the present invention, however. The other films have oxygen permeabilities of from 2 to 15 cm³/(m² bar d).

Tests are also carried out to determine the sterilization stability. Here, the sterilization is carried out in a full water autoclave. For this purpose, film pouches made of the film to be tested and filled with water are sealed or the film is fixed in a metal frame and in each case sterilized at 130° C. for 60 minutes. After sterilization, the film specimens are dried off gently and immediately clamped in the respective measuring instrument. After conditioning, the measurement is commenced and carried out over a time of some hours. These measurements, too, are carried out at an air temperature of 23° C. and 50% relative atmospheric humidity in accordance with DIN 53380-3.

As first illustrative embodiment, use is made of a gas barrier layer of a film according to the invention comprising 6 μm of polyamide, 8 μm of EVOH and 6 μm of polyamide which has been monoaxially stretched. As a comparative example, the same layer structure which had, however, been biaxially stretched is used. A second illustrative embodiment of the present invention comprises 6 μm of polyamide, 8 μm of EVOH and 6 μm of polyamide arranged via a laminating adhesive on a 75 μm-thick polypropylene layer (flat film). As a comparative example, use is made of an unstretched material as is described in DE 602 12 816.

In both illustrative embodiments, nucleated polyamide 6 and a sterilization-stable EVOH having an ethylene content of 29% are used.

The films according to an illustrative embodiment of the present invention have an oxygen permeability of less than 1 cm³/(m² bar d) before sterilization. This also applies to the unstretched material as per DE 602 12 816. The biaxially stretched film has a gas permeability of from 1.5 to 2 cm³/(m² bar d) even before sterilization. The packaging films according to illustrative embodiments of the present invention which have monoaxially stretched gas barrier layers have an oxygen permeability value of less than 1 cm³/(m² bar d) just 4 hours after sterilization. After just 4 hours, the retort shock has consequently abated to such an extent that satisfactory oxygen impermeability could be ensured again. The film which has an otherwise identical structure but has a biaxially stretched gas barrier layer has an oxygen permeability of about 500 cm³/(m² bar d) after 4 hours. Only after 115 hours does this value decrease to below 4 cm³/(m² bar d). The unstretched film as per DE 602 12 816 has a permeability of over 100 cm³/(m² bar d) for oxygen after sterilization, and this decreases to the critical value of 1 cm³/(m² bar d) only after more than 200 hours.

In addition, the biaxially stretched film has a white color after sterilization and subsequent drying, which is presumably attributable to the formation of vacuoles within the layer. Biaxial stretching, as is known from the prior art for improving the gas barrier layer, consequently stresses the EVOH to such an extent that it is no longer suitable for sterilization applications.

1. A packaging film for packaging products to be sterilized, comprising:
a gas barrier layer; and
a sealing layer,
wherein the gas barrier layer has at least three sublayers with two outer sublayers composed of a polyamide (PA) and a middle sublayer which is arranged between the outer sublayers and is composed of ethylene-vinyl alcohol copolymer (EVOH), which sublayers are coextruded, wherein the gas barrier layer is monoaxially stretched.

2. The packaging film according to claim 1, wherein the sealing layer is comprised at least partly of polypropylene (PP).

3. The packaging film according to claim 1, wherein the sealing layer has a plurality of sublayers and comprises at least one sublayer composed of polypropylene (PP) and at least one sublayer composed of polyamide (PA) which are coextruded and joined by means of a bonding agent.

4. The packaging film according to claim 1, wherein the sealing layer comprises at least two sublayers composed of polyamide (PA) and at least two sublayers composed of polypropylene (PP) which are coextruded and arranged alternately and are joined by means of a bonding agent.

5. The packaging film according to claim 1, wherein the sealing layer is comprised at least partly of a copolyester.

6. The packaging film according to claim 1, further comprising an additional support layer.

7. The packaging film according to claim 6, wherein the support layer is selected from the group consisting of a biaxially stretched polyamide (BOPA), a biaxially stretched polyester (BOPET), a biaxially stretched polypropylene (BOPP), and a paper.

8. The packaging film according to claim 6, wherein the support layer is arranged either between the gas barrier layer and the sealing layer, or on a side of the gas barrier layer facing away from the sealing layer.

9. A process for packaging products, comprising the steps of:
a) arrangement of a product in a packaging which is comprised at least partly of a packaging film comprising a gas barrier layer, and a sealing layer, wherein the gas barrier layer has at least three sublayers with two outer sublayers composed of a polyamide (PA) and a middle sublayer which is arranged between the outer sublayers and is composed of ethylene-vinyl alcohol copolymer (EVOH), which sublayers are coextruded, wherein the gas barrier layer is monoaxially stretched;
b) sealing the packaging by one or more of increasing a temperature or exerting a pressure on at least part of the packaging film; and
c) sterilization of the product in the sealed packaging.

10. The process according to claim 9, wherein the product is heated at at least 100° C. for a time of at least 10 minutes to effect sterilization.

11. The process according to claim 10 wherein the product is heated at at least 120° C.

12. The process according to claim 10 wherein the product is heated at at least 130° C.

13. The process according to claim 10 wherein the product is heated at least 30 minutes.

14. The process according to claim 10 wherein the product is heated at least 60 minutes.

15. The process according to claim 9 wherein said product is a foodstuff.

16. A packaged product, packed in a packaging, wherein the packaging which is comprised at least partly of a packaging film comprising a gas barrier layer, and a sealing layer, wherein the gas barrier layer has at least three sublayers with two outer sublayers composed of a polyamide (PA) and a middle sublayer which is arranged between the outer sublayers and is composed of ethylene-vinyl alcohol copolymer (EVOH), which sublayers are coextruded, wherein the gas barrier layer is monoaxially stretched, wherein the product has been sterilized in the packaging.

17. The packaged product of claim 16 wherein the product is a foodstuff.
